(19) United States
(12) Patent Application Publication
(10) Pub. No.: US 2019/0154494 A1
(43) Pub. Date: May 23, 2019

(54) DETECTING DEGRADATION IN ROTATING MACHINERY BY USING THE FWHM METRIC TO ANALYZE A VIBRATIONAL SPECTRAL DENSITY DISTRIBUTION

(71) Applicant: Oracle International Corporation, Redwood Shores, CA (US)

(72) Inventors: Kenny C. Gross, Escondido, CA (US); Mengying Li, La Jolla, CA (US); Aleksey M. Urmanov, San Diego, CA (US)

(73) Assignee: Oracle International Corporation, Redwood Shores, CA (US)

(21) Appl. No.: 15/821,593

(22) Filed: Nov. 22, 2017

(51) Int. Cl. G01H 1/00; G06F 17/14

(52) U.S. Cl. CPC G01H 1/003; G06F 17/142

(57) ABSTRACT

The disclosed embodiments relate to a system that detects degradation in one or more rotating components in a monitored system. During operation, the system receives one or more telemetry signals comprising vibration sensor readings from one or more vibration sensors in the monitored system. The system then performs a fast Fourier transform (FFT) on the vibration sensor readings to produce a power spectral density (PSD) distribution. Next, the system identifies a peak in the PSD distribution, wherein the peak is associated with a target rotating component in the monitored system. After identifying the peak, the system computes a full width half maximum (FWHM) value for a curve associated with the peak. Finally, if the FWHM value exceeds a pre-specified threshold, the system generates a notification about degradation of the target rotating component in the monitored system.

### BACKGROUND

### Field

The disclosed embodiments generally relate to techniques for monitoring the operational health of rotating machinery. More specifically, the disclosed embodiments relate to a technique for detecting degradation in rotating machinery by using a full width half maximum (FWHM) metric to analyze a spectral density of vibration sensor readings.

### Related Art

Many important industries rely on critical assets that include rotating machinery. This rotating machinery includes many types of mechanical components, such as fluid pumps, generators, motors, motor-generator sets, fans, blowers, compressors, turbines, gear boxes, and spindle motors. The common practice for prognostic monitoring of such business-critical assets with rotating machinery is to equip the assets with accelerometers to measure vibrational amplitudes. Thresholds are then placed on the measured vibrational amplitudes for these assets, because many age-related degradation modes cause vibrational amplitudes to rise as components degrade during service.

Such thresholds on vibration amplitudes are most appropriate for machines that have a constant “load” and run at a fixed speed for the life of the system, and also for constant-load machines that operate in an environment with a stationary ambient vibration level, which means that other vibrating components do not create a variable ambient vibration level. However, fixed workload components that continuously run at fixed RPMs, and are not mechanically coupled to any other components that add to the ambient vibration background, are very rare. For more-common systems with rotating machinery that: exhibit dynamic workloads; have variable-speed performance; or are mounted into structures that contain other dynamically varying vibration sources, thresholds on gross vibrational amplitudes are ineffective in detecting the early onset of degradation. This is because the thresholds have to be set higher than the highest peak for the component at its highest load, when the ambient vibration levels are highest. This significantly lowers the “early warning” potential for prognostics, because high thresholds on vibration amplitudes will not work effectively when components are not operating at peak load or during peak performance conditions.

Hence, what is needed is a prognostic-monitoring technique for rotating machinery that effectively detects the onset of degradation without the above-mentioned shortcomings of existing monitoring techniques.

### SUMMARY

The disclosed embodiments relate to a system that detects degradation in one or more rotating components in a monitored system. During operation, the system receives one or more telemetry signals comprising vibration sensor readings from one or more vibration sensors in the monitored system. The system then performs a fast Fourier transform (FFT) on the vibration sensor readings to produce a power spectral density (PSD) distribution. Next, the system identifies a peak in the PSD distribution, wherein the peak is associated with a target rotating component in the monitored system. After identifying the peak, the system computes a full width half maximum (FWHM) value for a curve associated with the peak. Finally, if the FWHM value exceeds a pre-specified threshold, the system generates a notification about degradation of the target rotating component in the monitored system.

In some embodiments, while generating the notification, the system additionally computes and outputs a remaining useful life (RUL) value for the target rotating component.

In some embodiments, computing the RUL value comprises using a predetermined relationship between FWHM and RUL values for the target rotating component to compute the RUL value, wherein the predetermined relationship was derived from sequences of FWHM values for similar rotating components that were previously run to failure.

In some embodiments, identifying the peak in the PSD distribution involves using input from an RPM sensor for the target rotating component to determine a location for the peak in the PSD distribution, wherein the location is associated with a fundamental frequency of the target rotating component.

In some embodiments, prior to computing the FWHM value for the identified peak, the system normalizes the curve associated with the identified peak to compensate for a variable speed of the target rotating component.

In some embodiments, while identifying the peak in the PSD distribution associated with the target rotating component, the system identifies multiple peaks in the PSD distribution associated with multiple target rotating components. Next, the system computes FWHM values for curves associated with the multiple identified peaks. Finally, if the FWHM value for any given peak in the multiple identified peaks exceeds a pre-specified threshold, the system generates a notification about degradation of a rotating component associated with the given peak.

In some embodiments, the system computes the FWHM value for the curve for the identified peak by computing a difference between two extreme frequency values for the curve at which the amplitude of the curve equals half of a maximum amplitude of the curve.

In some embodiments, the one or more vibration sensors in the monitored system comprise tri-axial accelerometers.

In some embodiments, the monitored system comprises one or more of the following: an enterprise computing system; a power generation plant; an oil refinery; and a motorized vehicle.

In some embodiments, the rotating component comprises one or more of the following: a fluid pump; a generator; a motor; a motor-generator set; a fan; a blower; a compressor; a turbine; a gear box; and a spindle motor.

### BRIEF DESCRIPTION OF THE FIGURES

FIG. 1 illustrates an exemplary enterprise computer system with a vibrational monitoring system in accordance with the disclosed embodiments.

FIG. 2 illustrates a PSD distribution for three different axes of a tri-axial accelerometer in an exemplary enterprise computer system in accordance with the disclosed embodiments.

FIG. 3A presents a graph illustrating a PSD peak for a good fan in accordance with the disclosed embodiments.

FIG. 3B presents a graph illustrating a PSD peak for a bad fan in accordance with the disclosed embodiments.

FIG. 3C presents a graph illustrating overlaid PSD peaks for good and bad fans on a normalized frequency scale in accordance with the disclosed embodiments.

FIG. 3D presents a graph highlighting FWHM ratios for overlaid PSD peaks for good and bad fans on a normalized frequency scale in accordance with the disclosed embodiments.

FIG. 4 presents a flow chart illustrating operations involved in detecting degraded rotational machinery in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a new prognostic-surveillance technique, which operates by applying a FWHM metric to a spectral distribution of vibration sensor readings in the frequency domain. By using this metric, the new technique decouples prognostic surveillance from dependence on the amplitude of vibrations in the asset under surveillance. As a result, the new technique provides high sensitivity annunciation for subtle degradation modes at the earliest incipience of the degradation, and has equally high sensitivity when the rotating machinery is operating during peak load conditions, or more importantly, when the machinery is operating at “normal” or lower load conditions, where conventional prognostic-surveillance techniques are quite insensitive. This new technique is also “self calibrating,” which means that it can be trained on a new asset, or on an asset for which there presently does not exist any known mechanical degradation modes. This new prognostic-surveillance technique can be used to monitor any type of rotating machinery, which is equipped with vibration sensors, such as motors, generators, pumps, fans, and blowers. Hence, this new prognostic-surveillance technique can be broadly applied to rotating machinery in various industries, such as utilities, transportation, manufacturing, oil and gas, and enterprise computing.

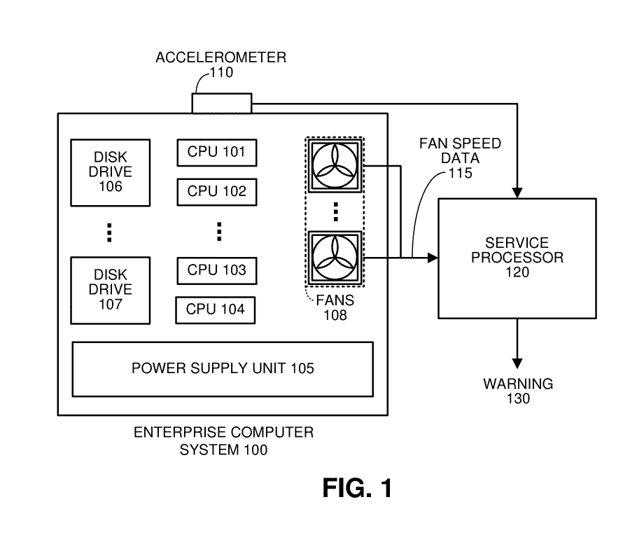

FIG. 1 illustrates an exemplary use case for this technique in an enterprise system 100 in accordance with the disclosed embodiments. As illustrated in FIG. 1, enterprise computer system 100 includes a number of CPUs 101-104 and a power supply unit (PSU) 105. In addition, enterprise computer system 100 includes a set of fans 108, which blow ambient air across CPUs 101-104 and PSU 105 to keep these components cool. Enterprise computer system 100 also includes disk drives 106-107, which store various files containing code and data to be executed by CPUs 101-104.

Note that enterprise servers typically do not include internal vibration sensors, so an external accelerometer 110 (which, for example, can be magnetically mounted) is attached to enterprise computer system 100. A sequence of accelerometer readings from accelerometer 110 feeds into a service processor along with fan speed data 115 from rotation-speed sensors in fans 108. Service processor 120 performs various computational operations on these inputs (which are described below) to detect degradation in rotating components within enterprise computer system 100, such as fans 108 and disk drives 106-107. Note that a single accelerometer 110 can be used to monitor all of the rotating components inside enterprise computer system 100 because each rotating component generates a distinct peak in a PSD distribution generated from the accelerometer readings as is described in more detail below.

In enterprise computer systems, fans are one of the most frequently replaced field replaceable units (FRUs). (Fans are second only to hard disk drives (HDDs), but not because HDDs are less reliable, rather because there are many more HDDs in the systems than fans.) Because fans are high-replacement FRUs, they are configured to be hot-swappable in most servers and integrated appliances. If a fan fails, it is straightforward for a field service engineer to determine what fan or fan tray has failed, and to replace that fan or fan tray. However, if a fan is experiencing degradation but has not completely failed, it is extremely difficult or impossible for service engineers to determine which fan (or fans) need to be replaced. There presently exist no diagnostic tests that can be performed in the field to differentiate degrading fans from good fans. In fact, if suspect fans are removed from customer machines, it is extremely nontrivial and quite expensive to differentiate degrading fans from good fans, even when the fans are shipped to a testing laboratory. This type of testing involves putting the fans into an instrumented flow chamber to detect a difference in CFM (cubic feet per minute) performance compared with normal, un-degraded fans.

Because it is difficult to distinguish degrading fans from good fans in enterprise computer systems, when a known degradation mode starts to arise in the installed base for a given model of fans, it is typical for the system vendor to perform a worldwide recall. Worldwide recalls are very costly and create significant customer dissatisfaction. Moreover, worldwide recalls to replace defective fans have been launched even when fewer than 10% of the fans are affected by the degradation mode, simply because it is not possible for field service engineers to distinguish degrading fans from good fans. Hence, when such an incident occurs, 90% of the fans returned from the field might be good fans. This means that 100% of the customers are upset even though only 10% of their fans may have led to further operational problems. This can be extremely costly, even when the FRUs are only the fans themselves. (Note that fans are less costly than many other components, such as motherboards, but are far more numerous and have higher failure rates than motherboards.) Unfortunately, it is increasingly common for Power Supply Units (PSUs) to be deployed with internal fans. In this case, it is not possible to replace just the fans, because entire PSUs with defective internal fans have to be replaced at a substantial cost.

Hence, what is needed is an effective technique for distinguishing degrading fans from good fans, without having to remove and ship the fans to a remote testing facility. By using this type of technique, a server vender can avoid the substantial cost of unnecessarily replacing good fans in customer server assets, for example through costly worldwide recalls.

The disclosed embodiments use a low-cost, tri-axial vibration sensor, such as a MEMS accelerometer or a FBG (fiber Bragg grating) sensor. This type of vibration sensor can be built into a server, or alternatively a tiny portable magnetically mounted sensor can be placed by a service engineer on an exposed external surface of a server. Empirical results demonstrate that a tri-axial vibration sensor, which is placed on an external surface of a server, can provide vibrational data with distinct spikes in the PSD distribution for each of the fans inside the server.

While it has been well-known that fans with degrading bearings, motor internal wear/degradation, or rotational axis eccentricity will vibrate at a higher amplitude than new, well-balanced fans, it has so far not been possible to use this increased vibrational amplitude to facilitate real-time diagnosis of fan degradation in enterprise computing servers. There exist a number of reasons why such real-time diagnosis is not presently possible.

(1) Enterprise servers include multiple fans. For fault-tolerance purposes alone, an enterprise server needs to have at least two fans. Thanks to the increasing heat generation associated with Moore's law, there presently exist numerous fans even in the smallest servers, including main fans, PSU fans, and additional CPU fans. For example, a typical 4RU server, such as in Oracle's X4500 system, contains a total of 14 fans, and high-end servers can have 20 or more fans. All of the internal fans have varying vibrational performance, even when new. Because of the large number of fans inside a server, and the additive nature of vibrations, it is presently not possible to apply a simple threshold to vibrational PSD amplitudes to detect degradation of individual fans.

(2) Depending upon where the accelerometer is placed, there will be varying transmission distances and coupling efficiencies between the operating fans and the accelerometer, even if all of the fans inside the server were identical. Again, it is not possible to apply a simple threshold to vibrational PSD amplitudes to detect degradation of individual fans because a well-balanced new fan that is close to the accelerometer could trip a degradation threshold, whereas a worn fan with degraded bearings that is on the far side of the server might exhibit a PSD amplitude that is below the degradation threshold.

(3) Almost all fans in enterprise servers are variable-speed fans. Again, one cannot apply a threshold to vibrational PSD amplitudes to detect degradation of individual fans because when CPU workloads are low (and/or ambient temperatures are cool), the PSD amplitudes will be relatively small. However, as CPU workloads (and/or ambient temperatures) rise, the fan speeds will increase and the vibrational PSD amplitudes will consequently be larger, even for new, well-balanced fans.

(4) For any given fan inside a server, the sensed vibrational amplitude will be smaller when that server is the only server inside a rack, versus if the same server is in a metal rack full of other executing servers. This is because the ambient external vibration levels are additive to the vibrations sensed from any one fan.

To overcome the above-described challenges, which have limited the effectiveness of vibration-based diagnostics for enterprise server fans, we use a new dimensionless metric that facilitates accurate and unambiguous discrimination between rotating components that are well-functioning and rotating components that are worn and exhibiting degradation symptoms, which often lead to failure. Such degradation symptoms can be caused by bearings being out-of-roundness, lubrication dry-out mechanisms, lubrication gritting via dust accumulation, radial imbalance of a rotational shaft, internal mechanical degradation of motors, and impeller/vane degradation.

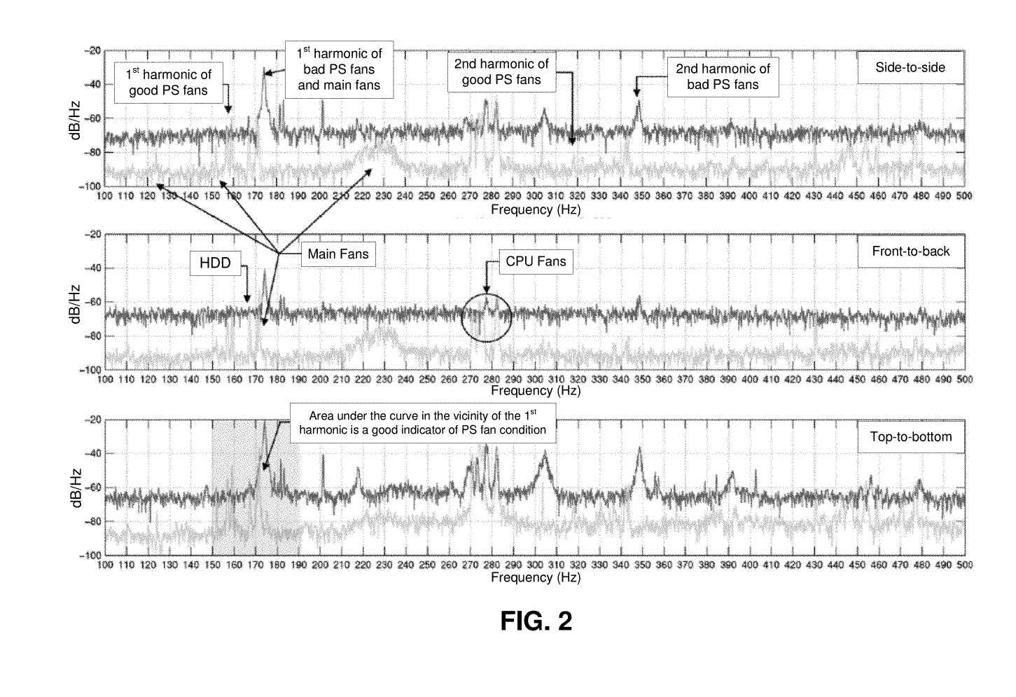

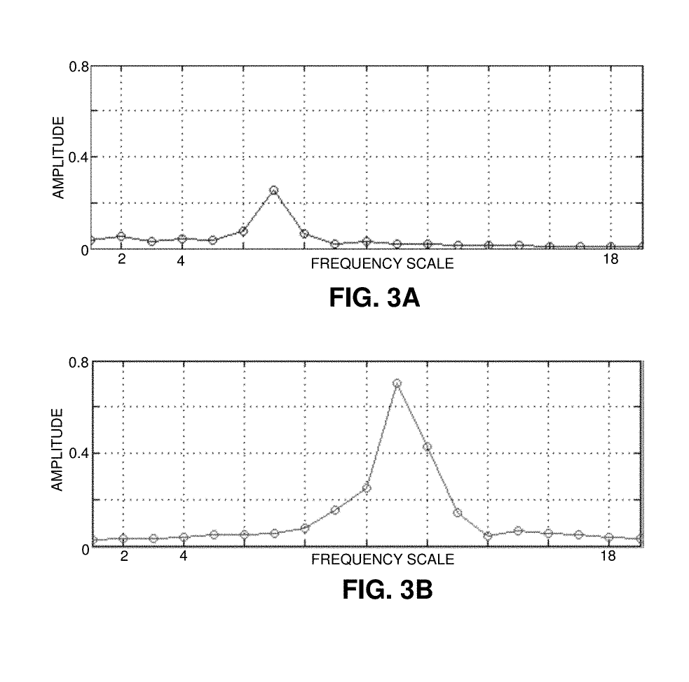

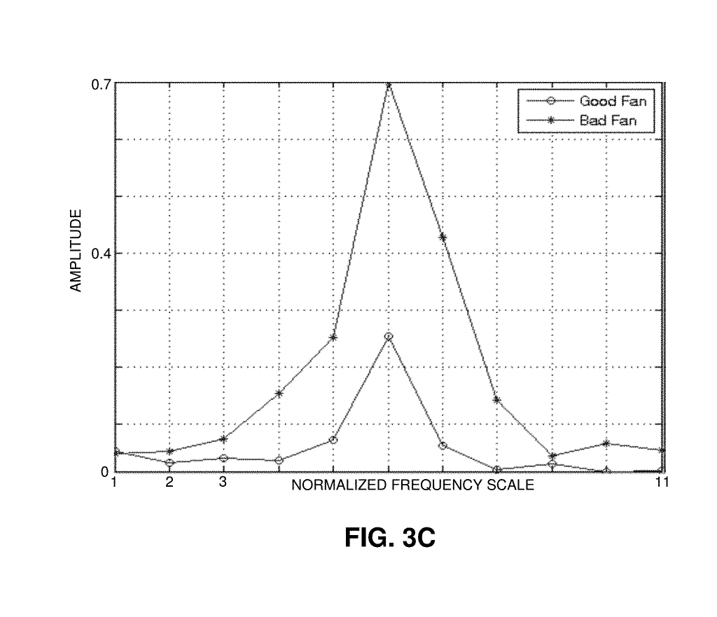

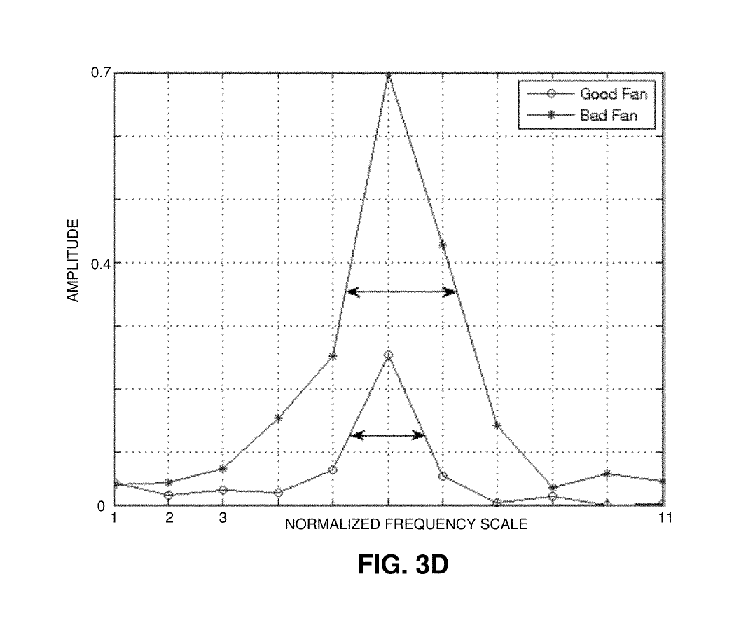

The peak amplitudes in the PSD for the server are identified and analyzed sequentially using a new technique, which is discussed with reference to FIGS. 2, 3A-3D and FIG. 4 below. FIG. 2 illustrates a PSD distribution for three different axes of a tri-axial accelerometer in an exemplary enterprise computer system in accordance with the disclosed embodiments. Moreover, FIGS. 3A and 3B present highly magnified portions of the PSD distribution illustrated in FIG. 2. In particular, FIG. 3A presents a PSD plot for a single peak associated with the fundamental rotational frequency of a new, well-balanced fan, and FIG. 3B presents a PSD plot for a single peak associated with the fundamental rotational frequency a worn fan from the field. Note that the fundamental frequencies (scaled on the x axis) are different for the two fans as illustrated in FIGS. 3A and 3B. This is expected because variable-speed fans can operate across a wide range of allowable frequencies. To compensate for this fact, the disclosed technique aligns the fundamental frequencies for all fans inside the server on a normalized frequency scale. This alignment is illustrated in FIGS. 3C and 3D, which overlays the PSD plots from FIGS. 3A and 3B on the normalized frequency scale.

It would be tempting to try to measure the area under the PSD curve to detect degradation in fan motor vibrational health. Indeed, in FIG. 3D one can see that the degraded fan exhibits a significantly larger area under the PSD curve as compared to the new, well-balanced fan. (Note that both of the fans used to generate FIGS. 3A-3D happen to be identical fans, but this is not a requirement for the new technique.) The reason that it is not feasible to use the area under the PSD curve as a degradation metric is that the area is strongly dependent on the height of the PSD peak. As previously explained, the various fans inside a server can have larger or smaller fundamental amplitudes for reasons that have nothing to do with age-related degradation. Consequently, it is possible for a new, well-balanced fan to have a high, narrow PSD spike, but still have a larger area-under-the-curve than a worn fan with bad bearings that happens to have a low vibrational amplitude, or is simply located farther away from the accelerometer. What is needed is a metric that decouples degradation discrimination from the gross vibration levels for the individual fans.

To achieve this, we introduce a new metric, which is analogous to a metric from nuclear radiation spectrometry that is used to assess the resolution of spectrometers: the FWHM metric. Referring to FIG. 3D, we define the FWHM metric to be the width in normalized frequency scale units at exactly one half of the height of the fundamental peak associated with each particular fan. We use this metric to generate a digitized time series of FWHM metric values, which is applied during steady state operation, or can also be applied during dynamic operation of the server. Note that no interruption of a customer's normal workload on any server needs to take place to perform this analysis. Also, note that the operational health of the internal fans can be quantitatively assessed using this new technique even during times when the internal fan speeds may be dynamically varying with changing customer workload dynamics.

Next, a configurable degradation threshold is placed on the digitized FWHM metric to unambiguously detect the presence of fan degradation for one or multiple fans inside a server, storage array, or appliance. In an exemplary embodiment, a threshold of 2.5 normalized frequency scale units is used with an accelerometer sampling rate of 10 KHz. This value has been found to provide good discrimination performance in real server systems.

### Process of Detecting Degraded Rotational Machinery

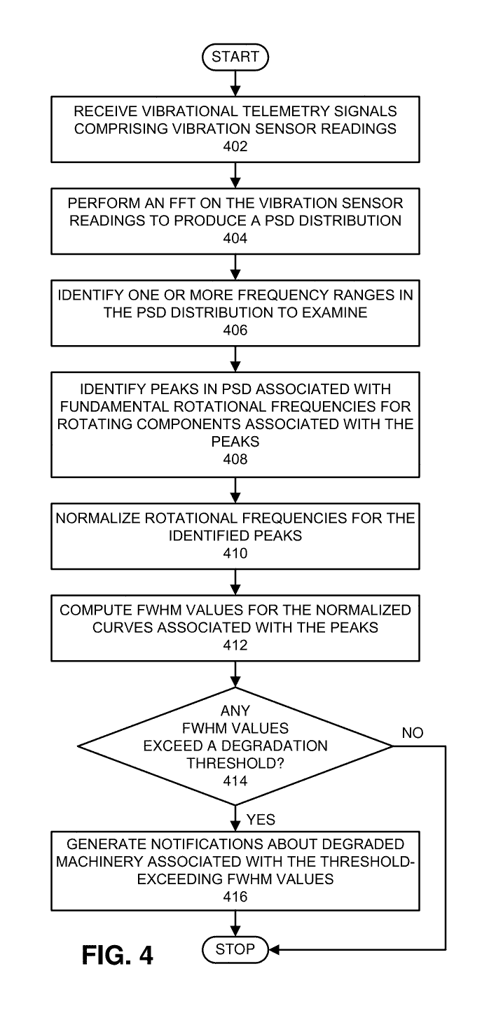

FIG. 4 presents a flow chart illustrating operations involved in detecting degraded rotational machinery in accordance with the disclosed embodiments. First, the system receives vibrational telemetry signals comprising vibration sensor readings from one or more vibration sensors in the monitored system (step 402). Next, the system performs an FFT on the vibration sensor readings to produce a PSD distribution (step 404). The system then identifies one or more frequency ranges in the PSD distribution to examine (step 406). (This can involve using input from RPM sensors attached to rotating machinery in the system under surveillance to identify the desired frequency ranges.) Next, the system identifies peaks in the PSD distribution, wherein the peaks are associated with fundamental frequencies for rotating components associated with the peaks (step 408). (Note that the system uses the RPM sensors to focus on peaks in the PSD distribution, which are associated the fundamental frequencies. In doing so, the system ignores other peaks, which are associated with integer multiples (harmonics) of the fundamental frequencies. By ignoring these integer-multiple harmonic peaks, the system is able to greatly simplify subsequent analysis operations.) After identifying the peaks, the system normalizes the rotational frequencies for the identified peaks (step 410), and then computes FWHM values for normalized curves associated with the peaks (step 412). Finally, the system determines whether any FWHM value exceeds a degradation threshold (step 414). If so, the system generates notifications about degraded rotation machinery associated with the threshold-exceeding FWHM values (step 416).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for detecting degradation in one or more rotating components in a monitored system, comprising:
receiving one or more telemetry signals comprising vibration sensor readings from one or more vibration sensors in the monitored system;
performing a fast Fourier transform (FFT) on the vibration sensor readings to produce a power spectral density (PSD) distribution;
identifying a peak in the PSD distribution, wherein the peak is associated with a target rotating component in the monitored system;
computing a full width half maximum (FWHM) value for a curve associated with the identified peak; and
if the FWHM value exceeds a pre-specified threshold, generating a notification about degradation of the target rotating component in the monitored system.

2. The method of claim 1, wherein generating the notification additionally comprises computing and outputting a remaining useful life (RUL) value for the target rotating component.

3. The method of claim 2, wherein computing the RUL value comprises using a predetermined relationship between FWHM and RUL values for the target rotating component to compute the RUL value, wherein the predetermined relationship was derived from sequences of FWHM values for similar rotating components that were previously run to failure.

4. The method of claim 1, wherein identifying the peak in the PSD distribution comprises using input from an RPM sensor for the target rotating component to determine a location for the peak in the PSD distribution, wherein the location is associated with a fundamental frequency of the target rotating component.

5. The method of claim 1, wherein prior to computing the FWHM value for the identified peak, the method further comprises normalizing the curve for the identified peak to compensate for a variable speed of the target rotating component.

6. The method of claim 1,
wherein identifying the peak in the PSD distribution associated with the target rotating component comprises identifying multiple peaks in the PSD distribution associated with multiple target rotating components;
wherein computing the FWHM value for the curve associated with the identified peak comprises computing FWHM values for curves associated with the multiple identified peaks; and
wherein if the FWHM value for any given peak in the multiple identified peaks exceeds a pre-specified threshold, the method further comprises generating a notification about degradation of a rotating component associated with the given peak.

7. The method of claim 1, wherein computing the FWHM value for the curve for the identified peak comprises computing a difference between two extreme frequency values for the curve at which the amplitude of the curve equals half of a maximum amplitude of the curve.

8. The method of claim 1, wherein the one or more vibration sensors in the monitored system comprise tri-axial accelerometers.

9. The method of claim 1, wherein the monitored system comprises one or more of the following:
an enterprise computing system;
a power generation plant;
an oil refinery; and
a motorized vehicle.

10. The method of claim 1, wherein the rotating component comprises one or more of the following:
a fluid pump;
a generator;
a motor;
a motor-generator set;
a fan;
a blower;
a compressor;
a turbine;
a gear box; and
a spindle motor.

11. A non-transitory, computer-readable storage medium storing instructions that when executed by a computer cause the computer to perform a method for detecting degradation in one or more rotating components in a monitored system, the method comprising:
receiving one or more telemetry signals comprising vibration sensor readings from one or more vibration sensors in the monitored system;
performing a fast Fourier transform (FFT) on the vibration sensor readings to produce a power spectral density (PSD) distribution;
identifying a peak in the PSD distribution, wherein the peak is associated with a target rotating component in the monitored system;
computing a full width half maximum (FWHM) value for a curve associated with the identified peak; and
if the FWHM value exceeds a pre-specified threshold, generating a notification about degradation of the target rotating component in the monitored system.

12. The non-transitory, computer-readable storage medium of claim 11, wherein generating the notification additionally comprises computing and outputting a remaining useful life (RUL) value for the target rotating component.

13. The non-transitory, computer-readable storage medium of claim 12, wherein computing the RUL value comprises using a predetermined relationship between FWHM and RUL values for the target rotating component to compute the RUL value, wherein the predetermined relationship was derived from sequences of FWHM values for similar rotating components that were previously run to failure.

14. The non-transitory, computer-readable storage medium of claim 11, wherein identifying the peak in the PSD distribution comprises using input from an RPM sensor for the target rotating component to determine a location for the peak in the PSD distribution, wherein the location is associated with a fundamental frequency of the target rotating component.

15. The non-transitory, computer-readable storage medium of claim 11, wherein prior to computing the FWHM value for the identified peak, the method further comprises normalizing the curve for the identified peak to compensate for a variable speed of the target rotating component.

16. The non-transitory, computer-readable storage medium of claim 11,
wherein identifying the peak in the PSD distribution associated with the target rotating component comprises identifying multiple peaks in the PSD distribution associated with multiple target rotating components;
wherein computing the FWHM value for the curve associated with the identified peak comprises computing FWHM values for curves associated with the multiple identified peaks; and
wherein if the FWHM value for any given peak in the multiple identified peaks exceeds a pre-specified threshold, the method further comprises generating a notification about degradation of a rotating component associated with the given peak.

17. The non-transitory, computer-readable storage medium of claim 11, wherein computing the FWHM value for the curve for the identified peak comprises computing a difference between two extreme frequency values for the curve at which the amplitude of the curve equals half of a maximum amplitude of the curve.

18. The non-transitory, computer-readable storage medium of claim 11, wherein the monitored system comprises one or more of the following:
an enterprise computing system;
a power generation plant;
an oil refinery; and
a motorized vehicle.

19. The non-transitory, computer-readable storage medium of claim 11, wherein the rotating component comprises one or more of the following:
a fluid pump;
a generator;
a motor;
a motor-generator set;
a fan;
a blower;
a compressor;
a turbine;
a gear box; and
a spindle motor.

20. A system that detects degradation in one or more rotating components in a monitored system, comprising:
at least one processor and at least one associated memory; and
a degradation-detection mechanism that executes on the at least one processor, wherein during operation, the degradation-detection mechanism:
receives one or more telemetry signals comprising vibration sensor readings from one or more vibration sensors in the monitored system;
performs a fast Fourier transform (FFT) on the vibration sensor readings to produce a power spectral density (PSD) distribution;
identifies a peak in the PSD distribution, wherein the peak is associated with a target rotating component in the monitored system;
computes a full width half maximum (FWHM) value for a curve associated with the identified peak; and
if the FWHM value exceeds a pre-specified threshold, generates a notification about degradation of the target rotating component in the monitored system.
